(19) United States
(12) Patent Application Publication
(10) Pub. No.: US 2026/0213824 A1
(43) Pub. Date: Jul. 23, 2026

(54) USER EQUIPMENT AUTONOMOUS BEAM SWITCH

(71) Applicant: QUALCOMM Incorporated, San Diego, CA (US)

(72) Inventors: Yan ZHOU, San Diego, CA (US); Yongle Wu, San Diego, CA (US); Kiran Venugopal, Green Brook, NJ (US); Jing Jiang, San Diego, CA (US); Raghu Narayan Challa, San Diego, CA (US); Hari Sankar, San Diego, CA (US); Tao Luo, San Diego, CA (US); Jelena M. Damnjanovic, Del Mar, CA (US); Alberto Rico Alvarino, San Diego, CA (US)

(21) Appl. No.: 19/034,383

(22) Filed: Jan. 22, 2025

(51) Int. Cl. H04B 7/06; H04L 5/00; H04W 24/10

(52) U.S. Cl. CPC H04B 7/0695; H04L 5/0048; H04W 24/10

(57) ABSTRACT

This disclosure provides methods and apparatuses for beam switching operations in wireless communication networks. In various examples, a user equipment (UE) obtains, from a network entity, a configuration indicating whether a user equipment (UE) autonomous beam switch is enabled or disabled. The UE obtains a reference signal in a first transmission beam. The UE obtains a measurement of the reference signal, the measurement triggering an update to a second transmission beam based on the UE autonomous beam switch being enabled. The methods and apparatuses provide lower memory requirements, reduced signaling overhead, and avoids misalignment between the network entity and UE.

### TECHNICAL FIELD

The present disclosure relates to wireless communication, and more particularly, to methods and apparatuses for beam management procedures.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to obtain, from a network entity, a configuration indicating whether a UE autonomous beam switch is enabled or disabled; obtain a reference signal in a first transmission beam; and obtain a measurement of the reference signal, the measurement triggering an update to a second transmission beam based on the UE autonomous beam switch being enabled.

Another innovative aspect of the subject matter described in this disclosure may be implemented in a method of wireless communication performable at a UE. The method includes obtaining, from a network entity, a configuration indicating whether a UE autonomous beam switch is enabled or disabled; obtaining a reference signal in a first transmission beam; and obtaining a measurement of the reference signal, the measurement triggering an update to a second transmission beam based on the UE autonomous beam switch being enabled.

Another innovative aspect of the subject matter described in this disclosure may be implemented in an apparatus for wireless communication, wherein the apparatus isa network entity. The apparatus includes one or more memories, and one or more processors each communicatively coupled with at least one of the one or more memories. The one or more processors, individually or in any combination, are operable to cause the apparatus to transmit, to a communications device, a configuration indicating whether a UE autonomous beam switch is enabled or disabled; transmit a reference signal in a first transmission beam; and obtain a measurement of the reference signal, the measurement triggering an update to a second transmission beam based on the UE autonomous beam switch being enabled.

Another innovative aspect of the subject matter described in this disclosure may be implemented in a method of wireless communication performable at a network entity. The method includes transmitting, to a communications device, a configuration indicating whether a UE autonomous beam switch is enabled or disabled; transmitting a reference signal in a first transmission beam; and obtaining a measurement of the reference signal, the measurement triggering an update to a second transmission beam based on the UE autonomous beam switch being enabled.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 shows a diagram illustrating an example disaggregated base station architecture.

FIG. 3A is a diagram illustrating an example of a first frame, in accordance with various aspects of the present disclosure.

FIG. 3B is a diagram illustrating an example of DL channels within a subframe, in accordance with various aspects of the present disclosure.

FIG. 3C is a diagram illustrating an example of a second frame, in accordance with various aspects of the present disclosure.

FIG. 3D is a diagram illustrating an example of UL channels within a subframe, in accordance with various aspects of the present disclosure.

FIG. 4 is a diagram illustrating an example of a base station and a user equipment (UE) in an access network.

FIG. 5 is a diagram illustrating an example of a UE autonomous update of TCI.

FIG. 6 is a diagram illustrating an example of a UE autonomous measurement RS update.

FIG. 7 is a call flow diagram between a UE and a base station.

FIG. 8 is a flowchart of a method of wireless communication performable at a UE.

FIG. 9 is a flowchart of a method of wireless communication performable at a network entity.

FIG. 10 is a diagram illustrating an example of a hardware implementation for an example apparatus.

FIG. 11 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Aspects of the present disclosure relate to next generation, multi carrier operation and the beam switching by a base station. For multi-carrier systems, such as those expected in 6G, multiple frequency bands (e.g., sub-6 GHz (FR1), mmWave, and THz (FR3)) are used simultaneously to deliver high data rates, low latency, and massive connectivity. Explicit beam switching enhances these operations by dynamically directing narrow, high-gain beams to specific users or areas, ensuring optimal signal quality and reducing interference across multiple carriers. This is especially critical as higher-frequency bands in multi-carrier systems have shorter range and are more susceptible to obstacles. By seamlessly coordinating beam adjustments with multi-carrier management, networks can maintain reliability, improve spectral efficiency, and adapt to dynamic traffic patterns, enabling advanced services like massive IoT, enhanced mobile broadband, and ultra-reliable low-latency communications.

Accordingly, transmission configuration indication (TCI) switch signaling is a mechanism used in wireless communication systems to manage and optimize beam-based transmission between a base station and user equipment (UE). TCI allows the base station to signal the UE about changes in transmission and reception beam configurations, ensuring the use of optimal beams for specific resources, such as downlink shared channels or uplink control channels. By dynamically adapting to changes in the environment, such as user mobility, obstacles, or interference, TCI switch signaling enhances signal quality and reliability. TCI may be conveyed through control messages like Downlink Control Information (DCI) or Radio Resource Control (RRC), ensuring low signaling overhead while maintaining flexibility. This mechanism is essential for optimizing beamforming, especially in high-frequency bands, and plays a vital role in achieving the performance, efficiency, and reliability required in next-generation wireless networks. For example, UE autonomous beam update can be enabled at least when TCI and associated reference signals are used mainly for measurement (e.g., no QCL-TypeD reference signal being present in the TCI for DL/UL beam indication for FR1 and potentially FR3). In this way, this approach may also save TCI switch signaling/latency if the base station prefers UE autonomous bema update and avoid misalignment between the base station and UE.

In FR1, implementations of TCI/measurement reference signal switch may be different across base station vendors. For example, some vendors may follow the explicit TCI and measured reference signal as described in the standard. In addition, some base station vendors may not be compliant with standard specifications. In these cases, some vendors do not signal the updated TCI and corresponding measured reference signal(s), even when the best base station serving beam changes. As one example, if following the standards specification, the UE should stick to an old TCI or to the beam for the latest random-access channel (RACH) if no TCI is indicated. As another example, for non-standard specification compliant base station implementations without signaling the new TCI, UE implementation may autonomously update the TCI and corresponding measured reference signals by using the strongest Synchronization Signal Block (SSB). However, this is not compliant with the standard specification. More importantly, without knowing the intention of the base station for not signaling the new TCI, UE may switch to the strongest SSB conservatively by choosing a large reference signal received power (RSRP) difference threshold and/or long monitoring time, which will affect the measurement performance. Furthermore, this may lead to potential sync issues if the base station does not prefer to switch.

It would be helpful then for the base station to enable or disable UE autonomous beam updates for optimizing network performance in varying scenarios. As an example, at least for FR1, UE autonomous beam updates may be enabled when TCI and associated reference signal(s) are mainly for measurement (e.g., no QCL-TypeD reference signal being present in the TCI for DL/UL beam indication). In addition, the present disclosure describes at least two options for UE autonomous beam updates. First, the UE may autonomously select one TCI and use the associated reference signal(s) for various measurements associated with each TCI. Second, instead of TCI, the UE can directly autonomously update the reference signal(s) for various measurements, as the base station beam changes.

Particular aspects of the subject matter described in this disclosure may be implemented to realize one or more of the following potential advantages. In some examples, by enabling or disabling UE autonomous beam updates, the described techniques can be used to reduce signaling overhead and minimize misalignment between the UE and base station. Such an approach would be beneficial in dynamic environments or high-mobility scenarios, where rapid adjustments ensure robust connectivity. For example, allowing autonomous updates enables UEs to quickly adapt their beams to changing conditions, such as mobility, or signal degradation, reducing latency and offloading some beam management tasks from the base station. Conversely, disabling autonomous updates allows the base station to maintain full control over beam management, which is critical in dense or interference-prone networks requiring precise coordination. As another example, signaling overhead may be reduced by expecting UE to autonomously update the TCI, since the TCI in FR1 is mainly for measurement (e.g., Tracking Reference Signals (TRS), Path Loss Reference Signals (PL RS), and Reference Signals for Radio Link Monitoring (RLM) or Beam Failure Detection (BFD)) and not for data control (Tx/Rx) as in FR2. By toggling this feature, networks can balance efficiency, responsiveness, and control to meet specific operational demands, ensuring optimal performance in diverse deployment scenarios.

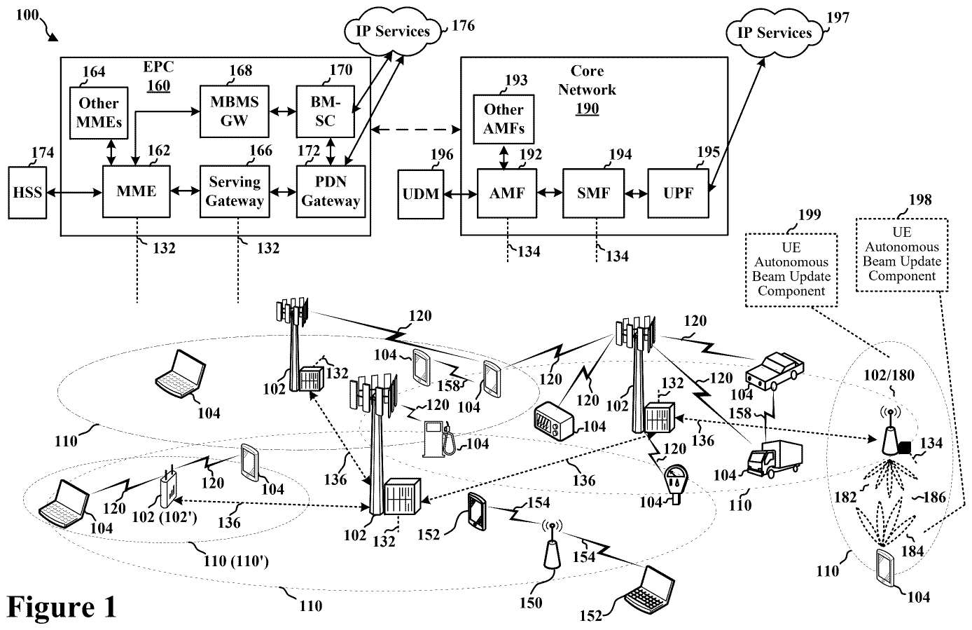

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′may have a coverage area 110′that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

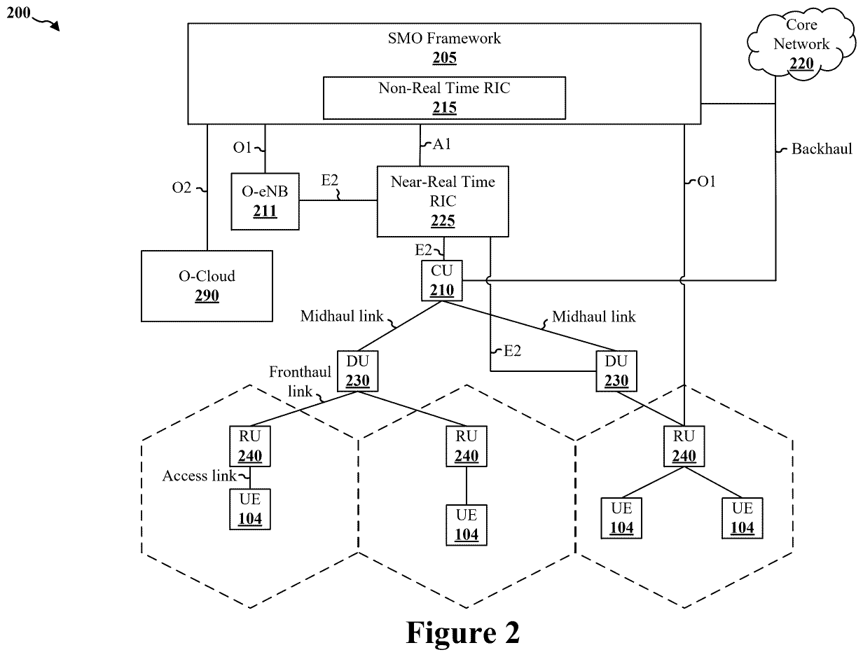

FIG. 2 shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include RRC, packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1 and 2, in certain aspects, the UE 104 may include a UE autonomous beam update component 198 that is configured to obtain, from a network entity, a configuration indicating whether a UE autonomous beam switch is enabled or disabled; obtain a reference signal in a first transmission beam; and obtain a measurement of the reference signal, the measurement triggering an update to a second transmission beam based on the UE autonomous beam switch being enabled. The UE may obtain the configuration and receive the one or more DCIs from base station 102/180, disaggregated base station 181, a component of disaggregated base station 181 such as CU 183, DU 185, or RU 187, or some other network entity.

Furthermore, in certain aspects, a network entity such as base station 102/180, disaggregated base station 181, or a component of disaggregated base station 181 such as CU 183, DU 185, or RU 187, may include a UE autonomous beam update component 199 that is configured to transmit, to a communication device, a configuration indicating whether a UE autonomous beam switch is enabled or disabled; transmit a reference signal in a first transmission beam; and obtain a measurement of the reference signal, the measurement triggering an update to a second transmission beam based on the UE autonomous beam switch being enabled. The network entity may send the configuration and transmit the configuration, reference signal, and/or measurement of the reference signal to UE 104 or a different UE.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

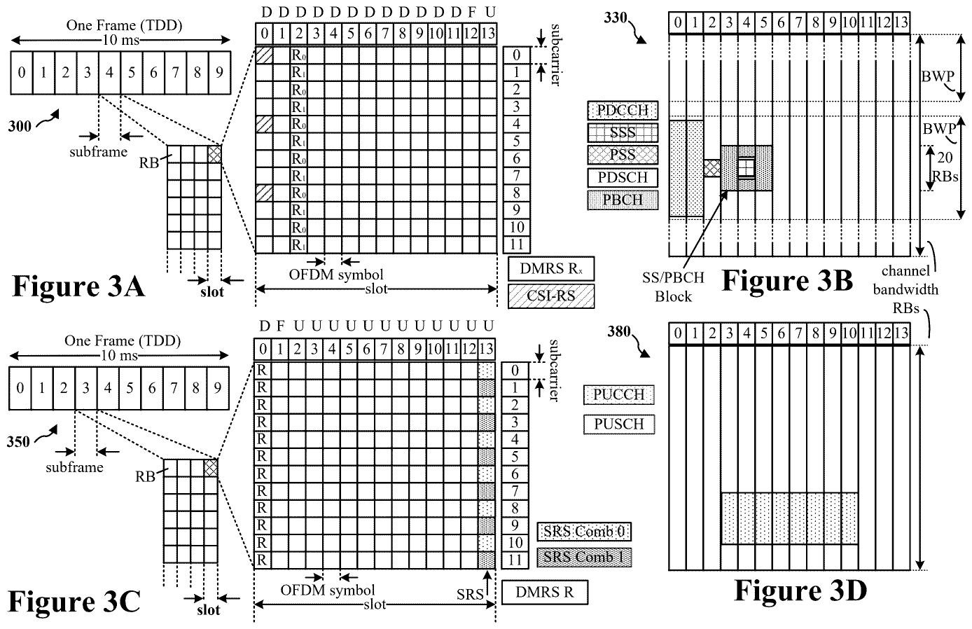

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

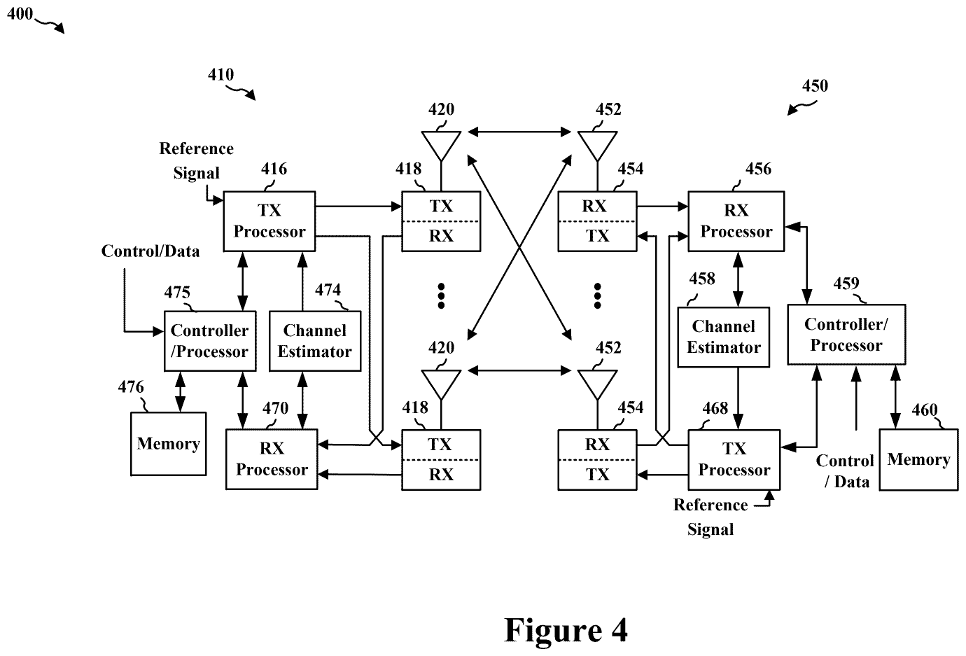

FIG. 4 is a block diagram of a base station 410 in communication with a UE 450 in an access network. In the DL, IP packets from the EPC 160 may be provided to one or more controllers/processors 475. The one or more controllers/processors 475 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 475 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 416 and the one or more receive (RX) processors 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 416 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate an RF carrier with a respective spatial stream for transmission.

At the UE 450, each receiver 454RX receives a signal through its respective antenna 452. Each receiver 454RX recovers information modulated onto an RF carrier and provides the information to the one or more receive (RX) processors 456. The one or more TX processors 468 and the one or more RX processors 456 implement layer 1 functionality associated with various signal processing functions. The one or more RX processors 456 may perform spatial processing on the information to recover any spatial streams destined for the UE 450. If multiple spatial streams are destined for the UE 450, they may be combined by the one or more RX processors 456 into a single OFDM symbol stream. The one or more RX processors 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the one or more controllers/processors 459, which implement layer 3 and layer 2 functionality.

The one or more controllers/processors 459 may each be associated with one or more memories 460 that store program codes and data. The one or more memories 460, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 459 provide demultiplexing between transport and logical channels, packet reassembly, deciphering, header decompression, and control signal processing to recover IP packets from the EPC 160. The one or more controllers/processors 459 are also responsible for error detection using an ACK and/or NACK protocol to support HARQ operations.

Similar to the functionality described in connection with the DL transmission by the base station 410, the one or more controllers/processors 459 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the one or more TX processors 468 to select the appropriate coding and modulation schemes, and to facilitate spatial processing. The spatial streams generated by the one or more TX processors 468 may be provided to different antenna 452 via separate transmitters 454 TX. Each transmitter 454 TX may modulate an RF carrier with a respective spatial stream for transmission.

The UL transmission is processed at the base station 410 in a manner similar to that described in connection with the receiver function at the UE 450. Each receiver 418 RX receives a signal through its respective antenna 420. Each receiver 418 RX recovers information modulated onto an RF carrier and provides the information to one or more RX processors 470.

The one or more controllers/processors 475 may each be associated with one or more memories 476 that store program codes and data. The one or more memories 476, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 475 provide demultiplexing between transport and logical channels, packet reassembly, deciphering, header decompression, control signal processing to recover IP packets from the UE 450. IP packets from the one or more controllers/processors 475 may be provided to the EPC 160. The one or more controllers/processors 475 are also responsible for error detection using an ACK and/or NACK protocol to support HARQ operations.

At least one of the one or more TX processors 468, the one or more RX processors 456, and the one or more controllers/processors 459 may be configured to perform aspects in connection with UE autonomous beam update component 198 of FIG. 1.

At least one of the one or more TX processors 416, the one or more RX processors 470, and the one or more controller/processors 475 may be configured to perform aspects in connection with UE autonomous beam update component 198 of FIG. 1.

A carrier in wireless communications refers to a modulated waveform conveying a physical channel. For instance, a carrier may refer to a modulated waveform conveying an E-UTRA, UTRA, or GSM physical channel defined by a code, frequency, and in some cases, a time-slot. Each carrier is supported by a channel bandwidth. For instance, a channel bandwidth may refer to a radio frequency (RF) bandwidth supporting a single RF carrier with a transmission bandwidth configured in the uplink or downlink of a cell. A cell refers to a radio network object that may be uniquely identified by a UE from a broadcast identification over a geographical area from an access point, such as by UE 104 within coverage area 110 of FIG. 1. Examples of cells include primary cells (PCells), secondary cells (SCells), primary secondary cells (PSCell), special cells (SpCell), or other serving cells configured for a UE upon entry in an RRC connected mode. A bandwidth part refers to a subset of contiguous common resource blocks for a given numerology on a given carrier. For instance, a bandwidth part may refer to a subset of contiguous RBs within a channel bandwidth. A serving cell may be configured with one or multiple downlink and uplink BWPs. For example, a UE may be configured with multiple bandwidth parts in the downlink, with a single downlink bandwidth part being active at a given time. If configured for an SCell, the first DL BWP on the carrier to be activated or used upon activation of the SCell is referred to as the first active downlink BWP identifier (ID) given by firstActiveDownlinkBWP-Id. Similarly, UE may be configured with multiple bandwidth parts in the uplink, with a single uplink bandwidth part being active at a given time. If configured for an SCell, the first UL BWP on the carrier to be activated or used upon activation of the SCell is referred to as the first active uplink BWP identifier (ID) given by firstActiveUplinkBWP-Id. Thus, a carrier may be associated with a cell, a bandwidth in a cell, and multiple bandwidth parts in a cell.

Carrier aggregation (CA) refers to an aggregation of two or more carriers, also referred to as component carriers (CCs), in order to support wider transmission bandwidths. Carrier aggregation may be intra-band contiguous, intra-band non-contiguous, or inter-band. Intra-band contiguous CA refers to aggregation of contiguous CCs in a same operating band. Intra-band non-contiguous CA refers to aggregation of non-contiguous CCs in a same operating band. Inter-band CA refers to aggregation of CCs in different operating bands. In some cases, an RF bandwidth may include multiple sub-blocks, which respectively refer to contiguous allocated blocks of spectrum for transmission and reception by a same UE.

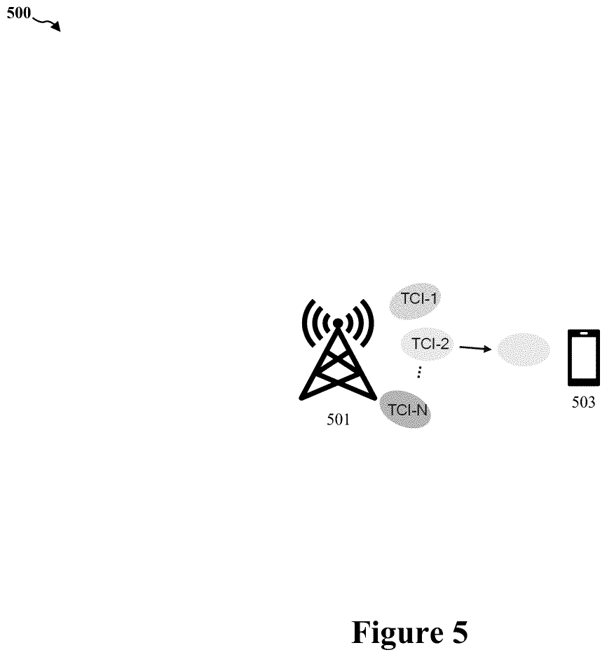

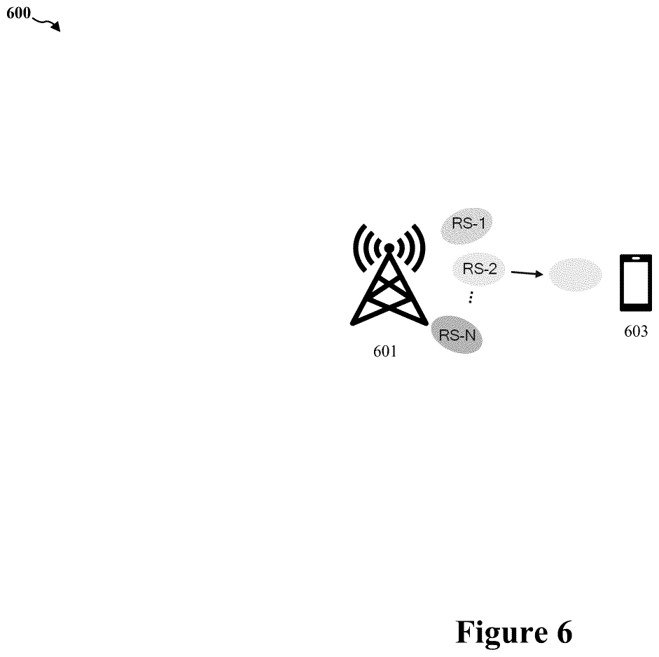

The present disclosure describes a process for the base station (e.g., gNB) to enable or disable UE autonomous beam updates to optimize network performance. For instance, in the case of FR1, UE autonomous beam updates may be enabled when the TCI and its associated reference signals are primarily intended for measurement purposes (e.g., when there is no QCL-TypeD reference signal present in in the TCI for DL/UL beam indication). Specifically, the present disclosure outlines two approaches for UE autonomous beam updates. As shown in FIG. 5, the first option describes a scenario where the UE can autonomously select a TCI and utilize the associated reference signals for performing various measurements related to each TCI. As shown in FIG. 6, the second option describes a scenario where, rather than relying on the TCI, the UE can autonomously update the reference signals directly for various measurements as the base station beam configuration evolves.

FIG. 5 is a diagram illustrating an example of a UE autonomous TCI update. Example 500 describes a process where the autonomous beam update is enabled or disabled via an autonomous TCI state update. Specifically, example 500 shows a UE 503 autonomously selecting one TCI from multiple available TCIs and uses the associated reference signals for various measurements. This capability enables the UE 503 to dynamically adapt to varying network conditions by utilizing the associated reference signals—such as TRS, PL RS, and Reference Signals for RLM or BFD. By streamlining these measurements for each TCI, the UE ensures more efficient resource utilization, improved link reliability, and optimized performance in complex network environments.

The TCI selection (e.g., update to the new TCI) may be within the normal configured TCI pool or within a dedicated TCI pool, which is a subset of the normal pool. This mechanism highlights a flexible approach to TCI selection, where the UE 503 can choose a TCI from either the normal configured TCI pool or a dedicated TCI pool, which is a refined subset of the normal pool. This hierarchical selection allows for more targeted and efficient communication strategies. By using a dedicated TCI pool, the UE 503 can focus on a narrower set of configurations optimized for specific scenarios, such as enhanced beam management or specialized measurement requirements. This flexibility enhances network adaptability, optimizes resource allocation, and improves overall communication reliability in dynamic and high-density environments.

The base station 501 may also provide precise control over the application of autonomously updated TCIs by the UE 503. For example, for target channels or reference signals, such as a channel state information reference signal (CSI-RS) serving as the root quasi co location (QCL) source for a different target signal, the base station 501 could indicate that the autonomous update should not apply to such target channels. In other words, the autonomous update should not be adopted to the autonomously selected TCI and the base station uses separate radio resource control (RRC) flags to explicitly indicate this to the UE. This granularity ensures that only the appropriate signals and channels apply the autonomously updated TCI, allowing for tailored beamforming and resource management while preventing conflicts or unintended configurations. This approach enhances the precision of network operations and communication reliability.

FIG. 6 is a diagram illustrating an example of a UE autonomous measurement RS update. Example 600 shows UE autonomous update of a measured reference signal. In contrast to example 500 of FIG. 5 showing UE autonomous TCI update, example 600 shows that UE 603 can directly autonomously update the reference signal(s) used for various measurements without switching TCI. The reference signal selection can be among a set of configured reference signal(s) (e.g., SSBs, P CSI-RS, PL RS, etc.). For example, the measurement can be for a preconfigured PL RS and then, based on some measurement or criteria, the UE can update the PL RS to a different reference signal.

This direct autonomous update allows the UE 603 to continuously align its measurement processes with the most effective beam, ensuring robust signal quality and efficient communication. By eliminating reliance on explicit signaling for each beam adjustment, this capability enhances responsiveness, reduces latency, and supports seamless operation in fast-changing network environments, such as in high mobility or beamforming-intensive scenarios.

A flexible approach to reference signal selection can be implemented where the UE 603 can choose from a set of configured reference signal(s) (e.g., SSBs, P CSI-RS). This selection process enables the UE 603 to dynamically adapt its measurements and communication strategies based on the most suitable reference signal for the current network conditions. By leveraging a configurable set of signals, the network 601 can provide enhanced adaptability, ensure efficient resource utilization, and maintain high-quality connectivity even in complex or evolving deployment scenarios.

Similar to the TCI example shown in FIG. 5, the selected measurement reference signal can be applied to each intended target channel and/or reference signal, ensuring consistent and optimized alignment across various network operations. This approach allows the UE 603 to utilize a single, well-suited reference signal—such as a CSI-RS or SSB—for measurements and configurations related to specific channels or signals.

However, unlike the TCI example shown in FIG. 5, example 600 may not need configured TCIs due to a direct update of measured reference signal(s). Accordingly, example 600 illustrates a scenario where configured TCIs may be unnecessary due to the UE's ability to directly update measured reference signals. However, this introduces a few concerns. First, for uplink channels or reference signals using the autonomously updated reference signal as the PL RS, additional parameters such as Initial Power Offset (P0), alpha, and closed-loop index must still be provided by the base station for each target uplink channel or reference signal in the absence of a TCI. Second, for target channels or reference signals not intended to utilize the autonomously updated reference signal—such as a CSI-RS serving as the root QCL source—the base station 601 must explicitly notify the UE, for example, via separate flags for each target. These measures ensure proper configuration, alignment, and functionality in the absence of pre-configured TCIs.

In this way, example 600 depicts a method of enabling or disabling the UE autonomous beam update feature for measurement reference signals. Accordingly, enabling or disabling this feature would be specified per reference signal rather than per target channel at the TCI level.

In some examples, example 600 may work in conjunction with example 500 from FIG. 5 such that dynamically signaling is used only if the current Bandwidth Part (BWP) or cell has a RRC flag set to enable UE autonomous beam update. Otherwise, autonomous beam update is disabled, and the UE always follows the explicit beam update command. For example, it could be indicated that RRC flag would indicate per cell, per BWP, per individual channels, component carrier (CC) groups, or individual reference signals. In this way, the autonomously selected TCI or measured reference signals could be applied only to the channels or reference signals in that indicated range of those indicated RRC flags. For example, if the flag is per BWP, then all TCI applicable channels or reference signals could use this autonomously selected TCI or updated reference signal. As another example, if the flag is per individual channel or reference signal, then only corresponding target channels can use the autonomously selected TCI.

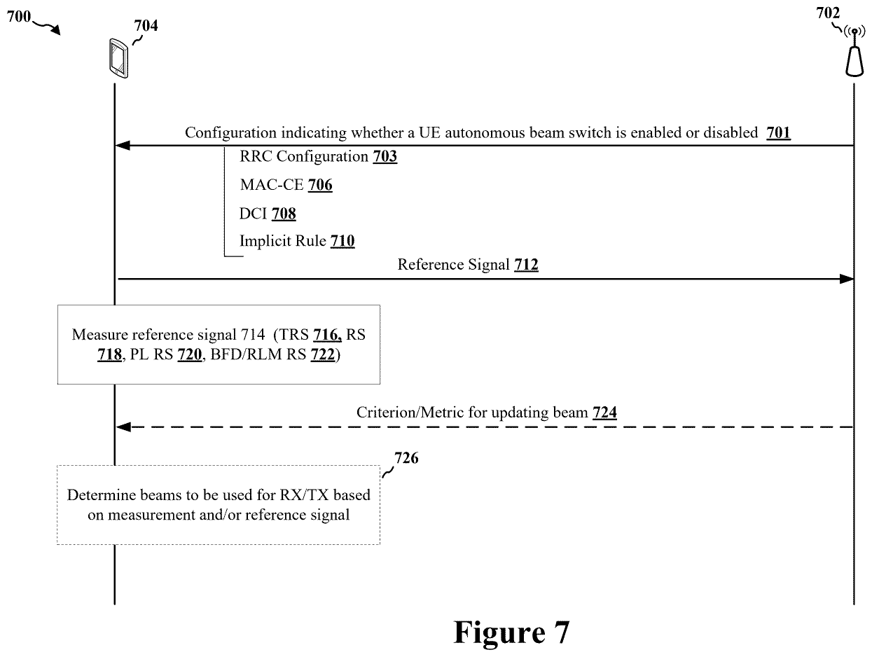

FIG. 7 illustrates an example 700 of a call flow between UE 704 and a base station 702. Here, base station 702 may correspond to base station 102, 410, and UE 704 may correspond to UE 104, 450. The illustrated example 700 depicts a beam switching process for reducing signaling overhead by allowing the network entity to enable or disable the UE 704 to perform UE autonomous beam update.

Example 700 may be applicable when TCI and associated reference signal(s) are mainly for measurement (e.g., no QCL-TypeD reference signal being present in the TCI for DL/UL beam indication) for FRI and, potentially, FR3. In these cases, such autonomous updates will not significantly impact the performance. Instead, the simple signaling used for determining whether an update is needed or not needed will allow the UE 704 to calibrate the receive algorithms accordingly.

In the illustrated example, the process may begin with the base station 702 transmitting a configuration 701 indicating whether a UE autonomous beam switch is enabled or disabled to the UE 704, and the UE 704 may receive the configuration 701 from the base station 702.

For example, the configuration 701 (e.g., signaling) to enable and/or disable UE autonomous beam updates may be indicated in a same configuration as an RRC configuration 703. The base station 702 may use RRC signaling to configure the UE 704 with one or more TCI states. These TCI states define the spatial transmission configuration and can correspond to specific beams or sets of reference signals such as CSI-RS or SSB. RRC signaling can be used to update TCI state configurations when there are changes in the network environment, user mobility, or beam quality, ensuring the UE 704 always uses the most efficient beam. By providing TCI states via RRC, the network ensures precise beam management, improves spectral efficiency, and minimizes interference in scenarios such as massive MIMO and millimeter wave communications.

In some examples, the TCI state may include a subset or all of the following options: joint DL/UL TCI state, separate DL TCI state, or separate UL TCI state. In the case where the serving cell is configured with both separate DL and UL TCI states, the indicator about enabling or disabling UE updates can be applicable to both. As a first option, the base station 702 can use a single indicator (or flag) to enable or disable UE autonomous beam update for both used separate DL and UL TCI states. As a second option, the base station 702 can use two indicators to enable or disable UE autonomous beam update for the used separate DL and UL TCI states, respectively. If disabled for UE autonomous beam update, the used separate DL or UL TCI state will follow the explicit TCI indication command from the base station 702.

Specifically, explicit RRC flags may be used and can be indicated per cell, BWP, individual channel/RS, or CC group. The autonomously selected TCI and/or reference signal will be applied to the channel(s) and/or reference signal(s) in the above indicated range of the flag. For example, if the flag is per BWP, then all TCI-applicable channel(s)/reference signal(s) will use the autonomously selected TCI. As another example, if the flag is per individual channel/reference signal, the corresponding target channel/reference signal will use the autonomously selected TCI.

In another example, the configuration 701 to enable and/or disable UE autonomous beam updates may be indicated via dynamic signaling such as a MAC-CE 706 or DCI 708. Based on the Layer 1 (L1) report, the base station 702 may indicate or activate a new TCI for the corresponding new base station serving beam. The measured reference signal(s) will be explicitly switched with the new TCI or via separate signaling to match the new beam. For example, when Medium Access Control Control Element (MAC-CE) or DCI activates or indicates at least one TCI, then UE 704 will follow the explicitly indicated TCI. Otherwise, UE 704 will follow the autonomously selected TCI. In some aspects, the dynamic signaling via MAC-CE 706 or DCI 708 may work together with RRC configuration 703 such that dynamic signaling is used only if the current BWP or cell has the RRC flag set to enable UE autonomous beam update. Otherwise, autonomous beam update is disabled, and the UE always follows the explicit beam update command (e.g., subsequent DCI with a new TCI state or scheduling/new configuration of a reference signal).

In yet another example, the configuration 701 to enable and/or disable UE autonomous beam updates may be based on an implicit rule 710. In some aspects, the implicit rules 710 may be specified or captured in standard specifications. In some aspects, the implicit rule 710 itself can be a signal from the base station 702 or programmed in software at the UE 704 side.

As a first example, an implicit rule 710 could be that autonomous beam switch used by the UE 704 is used if no QCL-TypeD reference signal is present in the TCI for DL/UL beam indication. This implicit rule could be applied to all or any subset of the configured, activated, and/or indicated TCI in a BWP, CC, or CC group. In other words, if QCL-TypeD is not required, then the default mode could be that the autonomous beam switch is always enabled for this case.

As a second example, an implicit rule 710 can be applied to certain bandwidths or frequency ranges (e.g., certain frequency ranges like FR1, bands, or band combinations). For example, when a reference signal or TCI is configured in a particular band and/or frequency range then the default mode could be that the UE 704 is expected to do the autonomous beam switch.

As a third example, an implicit rule 710 can be that UE 704 autonomously selected TCI/referenced signals will be applied to a target channel/reference signal if that target has no base station 702 explicitly provided TCI. For example, the target is either not configured to follow indicated TCI or has no separate TCI indicated to use. An additional rule could be that the autonomously selected TCI/reference signal should not be applied to a target RS serving as root QCL source RS (e.g., SSB or CSI-RS), where such CSI-RS can be indicated to UE 704.

As a fourth example, an implicit rule 710 can enable this feature depending on the number of configured beams (e.g., TCIs/SSBs) being above or below a threshold. For example, the feature may be applied if a total configured SSB or TCI number is more than 4.

After transmitting the configuration 702 to the UE 704, the base station 702 may transmit a reference signal 712, and the UE 104 may receive the reference signal 712.

Afterwards, the UE 704 may obtain the measurement of the reference signal 714.

The reference signal may be utilized for various measurements comprising at least one of TRS 716 (e.g., indicated/activated in TCI), Reference Signal 718 for beam determination (e.g., indicated/activated TCI in FR2), PL RS 720 (e.g., indicated/activated TCI), or BFD/RLM RS 722 associated with each TCI (e.g., explicitly configured by RRC or implicitly indicated by the QCL source RS in indicated/activated TCI for each monitored control resource set (CORESET)).

TRS 716 is a type of CSI-RS. TRS is primarily used to track and compensate for variations in the wireless channel caused by factors such as user mobility, environmental changes, and signal fading. In this way, precise estimation of time and frequency offset can be enabled, which are crucial for maintaining synchronization and optimizing signal quality. By providing reliable channel state information, TRS supports advanced features like beamforming, link adaptation, and mobility management, allowing the network to dynamically adjust to changing conditions and improve spectral efficiency. Furthermore, the TRS enhances the robustness of communication by aiding in the prediction and mitigation of potential disruptions, ensuring consistent quality of service and enabling the seamless delivery of high-speed, low-latency applications in next-generation networks.

Measured reference signal 718 could be the reference signals used for beam determination. In most cases, this is predominantly used for the millimeter wave (mmWave) communication in FR2 frequency ranges. In mmWave communication, beamforming is critical due to the high propagation losses and limited range of these high-frequency signals. Measured reference signals, such as SSBs or CSI-RS, are used to evaluate the quality of different beams. These signals provide key metrics like signal strength, signal-to-noise ratio, and path loss, which enable the UE 704 or base station 702 to identify the optimal beam for communication. This is particularly significant for FR2 frequencies, where narrow, highly directional beams are necessary to overcome the challenges of signal attenuation and to focus energy on the intended receiver. By using measured reference signals for beam determination, the system can dynamically select the best beam based on real-time channel conditions, ensuring robust connectivity and efficient utilization of spectrum resources.

The PL RS 720 is used by the UE 704 for determining the power control parameters used for uplink transmission. The PL RS is a critical element in wireless communication, used to estimate the path loss between a transmitter (e.g., a base station 702) and a receiver (e.g., user equipment, UE 704). Path loss refers to the reduction in signal power as it propagates through space, and the PL RS enables the UE to measure this attenuation and adjust its uplink transmission power accordingly. By using a reference signal, such as a Synchronization Signal (SS) or Channel State Information Reference Signal (CSI-RS), the UE 704 estimates the path loss and maps it to the required transmission power level. This dynamic adjustment ensures efficient and reliable uplink communication while minimizing interference with other users sharing the same frequency resources. Additionally, the UE 704 may communicate using the power control parameters derived from the PL RS back to the base station 702, allowing for better alignment of scheduling and resource allocation. This process not only optimizes the UE's energy consumption but also enhances network performance and maintains the quality of service for applications with stringent requirements. The PL RS can be indicated or activated via TCI.

The BFD/RLM RS 722 can be explicitly configured by RRC or the specification via which the UE 704 can determine the reference signals to monitor, which is typically based on the QCL source reference signal in the indicated or activated TCI derived from the monitored control resource (CORESET). BFD/RLM RS are crucial for effective beam management, ensuring reliable communication and optimal user experience. Beam failure detection involves monitoring the quality of the signal in a beam, typically through metrics such as signal-to-noise ratio (SNR) or RSRP. This helps identify when a beam is no longer providing acceptable signal quality, preventing service disruption or dropped connections. Radio link monitoring, on the other hand, tracks the link quality between the UE 704 and the base station 702, adapting to changing conditions like movement or obstacles. The TCI plays a vital role by associating a specific transmission configuration with beamforming parameters, helping the network and UE 704 determine which beam to use for optimal performance. When beam failure or poor link quality is detected, the TCI allows the UE 704 to quickly switch to an alternative beam with better characteristics, ensuring seamless communication. This dynamic adaptation, driven by the TCI, helps maintain high throughput, minimize outages, reduce latency, and enhance overall network efficiency, ensuring reliable connectivity even in challenging environments.

In some aspects, each TCI can be associated with a set of measurement reference signals. The measured reference signal may include at least one of TRS (e.g., in indicated or activated TCI), reference signal for beam determination (e.g., in indicated or activated TCI in FR2), PL RS (e.g., in indicated or activated TCI), or BFD/RLM reference signal (e.g., explicitly configured by RRC or implicitly indicated by the QCL source reference signal in indicated or activated TCI for each monitored CORESET) associated with each TCI.

In some aspects, if the UE autonomous beam update is enabled, the base station 702 may further indicate a criterion and/or metric 724 for the UE 704 to perform the autonomous update if the UE autonomous update is enabled by the base station 702. This gives more degree of control (e.g., more real-time or more relevant) to the operation scenario of the UE 704.

As an example, in the case of UE autonomous TCI update, the criterion could be to select the TCI whose QCL source reference signal (e.g., TRS in with TCI) or root QCL source reference signal (e.g., SSB QCLed to the TRS in the TCI) has the best metric. In this way, there may be some alignment between the base station 702 and the UE 704 in terms of the new beam that is selected based on the autonomous update. Different TCIs may be applied with different metrics/offsets/hysteresis (e.g., positive and negative offsets can be added to the metrics of currently used and not used TCIs, respectively) to mitigate frequent TCI switch. For example, if there are multiple TCIs that the UE 704 and the base station 702 can choose from and this criterion is enabled, then the selection of the new TCI or beam is also aligned.

In addition, the selection can be triggered when the criterion is satisfied for a certain duration. As another example, in the case of UE autonomous RS update, the criterion may be to select the reference signal with best metric or the one used by the UE for broadcast reception (e.g., SSB pair that MIB can be decoded with the most confidence). Similar to the TCI state update, corresponding offsets/hysteresis can be applied to different reference signals (e.g., currently used or not used reference signals) and the selection may also be triggered when the criterion is satisfied for a certain duration. In some aspects, the metric can be L1/L3 RSRP, SINR, RSRQ, and may be filtered with filtering parameters provided by the base station or the standard specification.

At 726, the UE 704 may obtain the measurements or reference signals to determine the beams to be used for receiving and transmitting data and control channels.

In some examples, the base station 702 may configure events to trigger UE autonomous TCI update. As an example, an event may be to select a new beam with a RSRP that is at least a threshold value better than the current beam. Another event may be to select a new beam when the quality of the current beam is worse than a predefined threshold (e.g., 1) and the quality of at least one new beam is better than a threshold (e.g., 2). Another event can be to select a new beam when the absolute value of the difference between the quality of the current beam and the quality of at least one new beam is lower than a threshold. Another event can be to select a new beam when the quality of a number of new beams (e.g., L1-RSRP) become a threshold value better than the current beam. Another event can be when a quality of at least one new beam (e.g., L1-RSRP) becomes a threshold value better than the configured reference signal (e.g., SSB or CSI-RS). The current and new beams refer to currently indicated/activated TCI and candidate TCI, respectively, whose quality can be measured based on QCL source reference signal in the TCI or the associated root QCL source reference signal. In addition, if multiple new beams satisfy the triggering event, then the UE 704 may select the one with the best quality.

A main benefit shown in example 700 is save TCI switching latency in terms of beam update signals or TCI indications between the base station 702 and the UE 704. Given that the feature is enabled or disabled, example 700 also shows a minimization between the base station 702 and the UE 704 due to a reduction in signaling between the base station 702 and the UE 704.

Instead of among all candidate TCI/beams, the autonomous update can be within each subgroup of candidate TCIs/beams, while the switch between different subgroups may still be explicitly signaled by the base station 702. For example, if a total 32 TCIs are configured and are split into two subgroups with 16 TCIs per group, then the base station 702 will indicate within which subgroup UE 704 should perform the autonomous beam update. The base station 702 may switch the subgroup if all TCIs in this subgroup have poor quality. In some cases, the base station 702 can be notified based on UE beam report, which can be event triggered (e.g., sending the report when all TCIs in the current subgroup have RSRP below a threshold).

In some embodiments, a current beam may be used as a comparison to a new beam for beam reporting. In these cases, if the current beam itself gets updated autonomously, there should be a mechanism for the base station 702 to determine what the current beam assumption used by the UE 704 is after the beam switch. To algin both sides on the current beam, the UE 704 may report the selected TCI to the base station 702, and the repot can be enabled or disabled by the base station 702. As a first option, the UE 704 may report the current beam/TCI whenever it changes (e.g., via scheduling request (SR), configured grant (CG), or piggyback in existing dynamic grant (DG)). As a second option, the UE 704 may autonomously report the current beam/TCI periodically (e.g., via SR, CG, piggyback in existing DG every X ms). As a third option, the base station 702 may simply request UE 704 to report the current beam/TCI assumption.

It should be noted that although the present disclosure describes a single Transmission Reception Point (TRP) use case, the present disclosure may be extended to multiple TRP or distributed TRP frameworks. Multiple TRP or distributed TRP frameworks refer to systems where multiple transmission/reception points work together in a coordinated manner to enhance network performance and coverage.

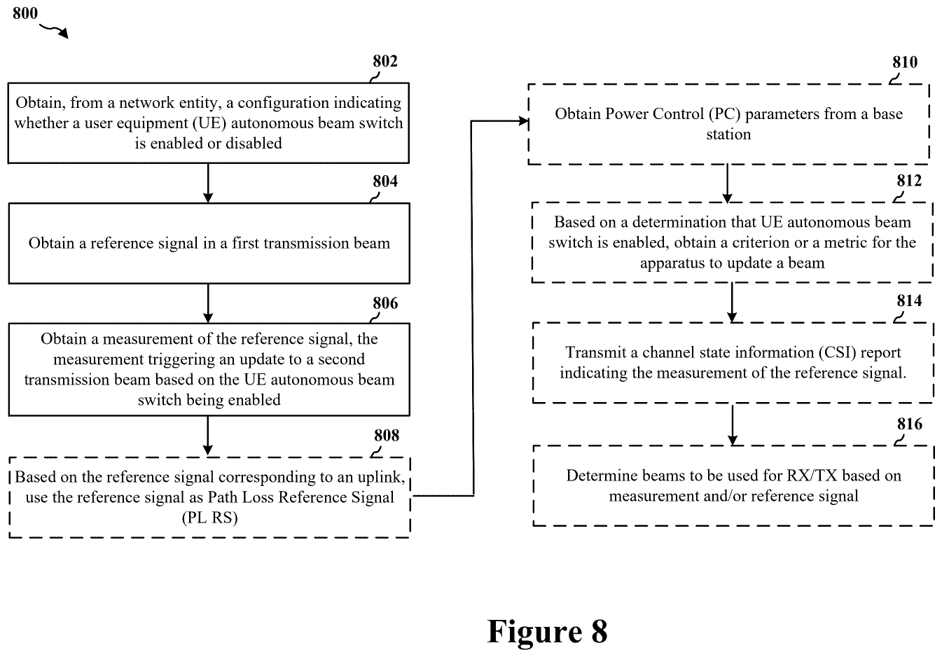

FIG. 8 is a flowchart of an example method 800 or process of wireless communication. The method may be performed by a UE such as the UE 104, 450, 704, or apparatus 1002 or its components as described herein. Optional aspects are illustrated in dashed lines. Optional aspects are illustrated in dashed lines. The method allows a UE to obtain a configuration from a base station to disable or enable UE autonomous beam update, thereby reducing signaling overhead by saving TCI switch signaling and latency and to avoid TCI misalignment between the base station and UE.

At block 802, the UE may obtain, from a network entity, a configuration indicating whether a user equipment (UE) autonomous beam switch is enabled or disabled. For example, block 802 may be performed by configuration component 1040. For instance, referring to the Figures, the controller(s)/processor(s) 459, the RX processor(s) 456, or a combination of these processor(s) of UE 704 may decode, demodulate, and receive via antennas 452, from base station 702, a configuration indicating whether a UE autonomous beam switch is enabled or disabled. As an example, referring back to FIG. 7, the UE 704 may obtain from the base station 702, a configuration indicating whether a UE autonomous beam switch is enabled or disabled.

In one example, the configuration indicating whether the UE autonomous beam switch is enabled or disabled is obtained via an explicit RRC flag such that the reference signal is applied to at least one channel or reference signal in an indicated range of the explicit RRC flag. In one example, the configuration indicating whether the UE autonomous beam switch is enabled or disabled is obtained via dynamic signaling. In one example, the dynamic signaling may correspond to a MAC-CE signal. In one example, the dynamic signaling may correspond to a DCI signal.

In one example, the configuration indicating whether a UE autonomous beam switch is enabled or disabled is obtained by an implicit rule comprising at least one of: (1) enabling the UE autonomous beam switch based on a determination of no QCL-TypeD RS in the TCI for DL/UL beam indication; (2) applying the configuration to a predetermined bandwidth; (3) applying the reference signal to a target channel or reference signal based on a target having no TCI provided by a base station; (4) not applying the reference signal to a target reference signal serving as root QCL source RS, wherein such CSI-RS can be indicated to the apparatus; (5) applying the reference signal based on a number of configured beams being above a predetermined threshold; and (6) applying the reference signal based on a number of configured beams being below the predetermined threshold.

In one example, the configuration indicating whether a UE autonomous beam switch is enabled or disabled is obtained based at least in part on detecting an event, wherein the event comprises at least one of: (1) quality of at least one new beam has a threshold value greater than a current beam; (2) quality of the current beam is lower than a first threshold and quality of at least one new beam is greater than a second threshold; (3) an absolute value of a difference between a quality of the current beam and the quality of at least one new beam is lower than a third threshold; (4) quality of more than one new beam becomes a threshold value greater than the current beam; and (5) quality of at least one new beam becomes a threshold value better than a configured reference signal of SSB or CSI-RS.

At block 804, the UE may obtain a reference signal in a first transmission beam. For example, block 804 may be performed by the reference signal component 1042. For instance, referring to the Figures, the controller(s)/processor(s) 459, the RX processor(s) 456, or a combination of these processor(s) of UE 704 may decode, demodulate, and receive via antennas 452, from base station 102, CSI-RS in a reference signal 712. As an example, referring back to FIG. 7, the UE 704 may obtain a reference signal 712 in the first transmission beam.

In one example, the first transmission beam may be indicated by a first TCI state. In one example, the reference signal is obtained from a set of reference signals comprising at least one of a SSBs or P CSI-RS. In one example, the TCI state comprises a subset of joint DL/UL TCI state, separate DL TCI state, or a separate UL TCI state. In one example, the TCI state includes a joint DL/UL TCI state, separate DL TCI state, and a separate UL TCI state.

At block 806, the UE may obtain a measurement of the reference signal. The measurement may trigger an update to a second transmission beam based on the UE autonomous beam switch being enabled. For example, block 806 may be performed by the measurement component 1044. For instance, referring to the Figures, after the controller(s)/processor(s) 459, the RX processor(s) 456, or a combination of these processor(s) of UE 704 decode, demodulate, and receive via antennas 452 the reference signals 712, the controller(s)/processor(s) 459 may perform measurements of the reference signal 714. As an example, referring back to FIG. 7, the UE 704 may obtain a measurement of the reference signal 714.

In one example, the reference signal is utilized for various measurements including at least one of TRS, PL RS, or BFD/RLM RS associated with each TCI.

In one example, the TCI selection may be from a normal configured TCI pool. In the case of a normal configured TCI pool, TCIs are selected from a general set of pre-configured beamforming configurations, which allows for flexible and dynamic management of beams across different UEs. These pools typically contain a wide variety of beam configurations that can be applied based on varying conditions such as interference levels, mobility, or user demand.

In another example, the TCI selection may be from a dedicated TCI pool. The dedicated TCI pool may be a subset of the normal configured TCI pool. The dedicated TCI pool refers to a smaller, specific subset of TCIs that are allocated exclusively for a particular UE or a group of UEs. This dedicated pool is typically used when more precise or tailored beam configurations are required, such as for high-priority users or specific use cases that demand optimal performance, low latency, or guaranteed quality of service. By using a dedicated TCI pool, the network can ensure that a specific UE has access to the best-suited beams, reducing the chances of interference and optimizing the connection.

Optionally, at block 808, the UE may, based on the reference signal corresponding to an uplink, use the reference signal as PL RS. The PL RS is a reference signal which the UE uses for determining the pathloss and the power control parameters to be used for uplink transmission. The PL RS may be activated or deactivated via TCI.

Optionally, at block 810, the method 800 may include obtaining Power Control (PC) parameters from the base station. The PC parameters may include at least one of P0, Power Control Alpha Parameter (alpha), or closed loop index. This highlights the importance of power control in ensuring reliable and efficient wireless communication between the UE and the base station. Power control is crucial for managing the transmit power levels of the UE, maintaining a strong and stable signal, preventing interference, and optimizing network efficiency. The parameters mentioned—P0, alpha, and Closed Loop Index—play specific roles in this process. P0 determines the starting transmit power when the UE connects with the base station, adjusting for factors like distance and interference. The alpha parameter controls how the UE adjusts the transmit power based on feedback from the base station, either increasing or decreasing it to maintain signal quality. Lastly, the Closed Loop Index is part of the closed-loop power control mechanism, where the base station continuously provides feedback to the UE to fine-tune its power adjustments. By obtaining these power control parameters provided by the network, the network helps the UE ensure optimal communication conditions, balancing power consumption, signal strength, and interference. This process is especially important in environments with variable network conditions, high mobility, or dense user populations, where maintaining effective power control is vital for network performance, reliability, and quality of service.

Optionally, at block 812, based on a determination that UE autonomous beam switch is enabled, obtaining a criterion or a metric for the apparatus to update a beam. In this way, the UE can autonomously manage its beam selection or adjustment based on certain conditions, such as signal quality or network demands, without direct intervention from the base station. This capability is significant because it enhances the efficiency and responsiveness of beam management in modern wireless networks, particularly in 5G and beyond, where beamforming is used to optimize signal strength and minimize interference. For example, block 806 may be performed by the criterion component 1046. As an example, referring back to FIG. 7, the UE 704 may obtain a criterion and/or metric for updating the beam when the UE autonomous beam switch is enabled.

When UE autonomous beam switching is enabled, the UE is allowed to evaluate its own communication environment and make decisions about whether to switch to a different beam, based on predefined criteria or metrics. This autonomy reduces the reliance on the base station to constantly manage beam adjustments, which can lead to faster responses to changing conditions such as user mobility, obstacles, interference, or signal degradation. By enabling the UE to handle its own beam switching, the network can be more flexible and responsive, especially in dynamic environments.

The criterion or metric used by the UE to determine when to update the beam can include several factors such as the signal-to-noise ratio (SNR), signal strength (e.g., RSRP), SINR (Signal to Interference plus Noise Ratio), or beam failure detection. If the UE detects that the current beam is not providing sufficient quality (for instance, if SNR drops below a threshold), it will initiate a switch to another beam that may offer better performance. These criteria ensure that the UE maintains an optimal connection to the base station while minimizing interference with other devices.

In one example, the criterion is used to select a TCI with a QCL source reference signal or root QCL source reference signal based on a metric.

In one example, the criterion is used to select the reference signal based on a metric.

In one example, the criterion is used to select the reference signal for broadcast reception.

In one example, the metric corresponds to Layer 1/Layer 3 (L 1/L3) RSRP, SINR, Reference Signal Received Quality (RSRQ).

In one example, the metric is filtered with filtering parameters.

Optionally, at block 814, the UE may transmit a CSI report indicating the measurement of the reference signal. For example, block 814 may be performed by the reporting component 1048. CSI is a key indicator used by the base station to assess the quality of the wireless link between the UE and the network. The reference signal, typically a known signal transmitted by the base station, serves as a benchmark for measuring various parameters of the communication channel, such as signal strength, interference, and quality. By reporting CSI based on these reference signals, the UE provides critical information that allows the base station to adaptively adjust transmission parameters, such as power levels, beamforming, or scheduling, to optimize the connection.

In one example, the CSI report is transmitted based on detecting a change in the measurement of the reference signal. In one example, the CSI report is transmitted periodically. In one example, the CSI report is transmitted based on obtaining a request.

Optionally, at block 816, the method 800 may include determining beams to be used for RX/TX based on the measurement/and or reference signal. As an example, referring back to FIG. 7, the UE 704 may determine beams to be used for RX/TX based on the measurement/and or reference signal.

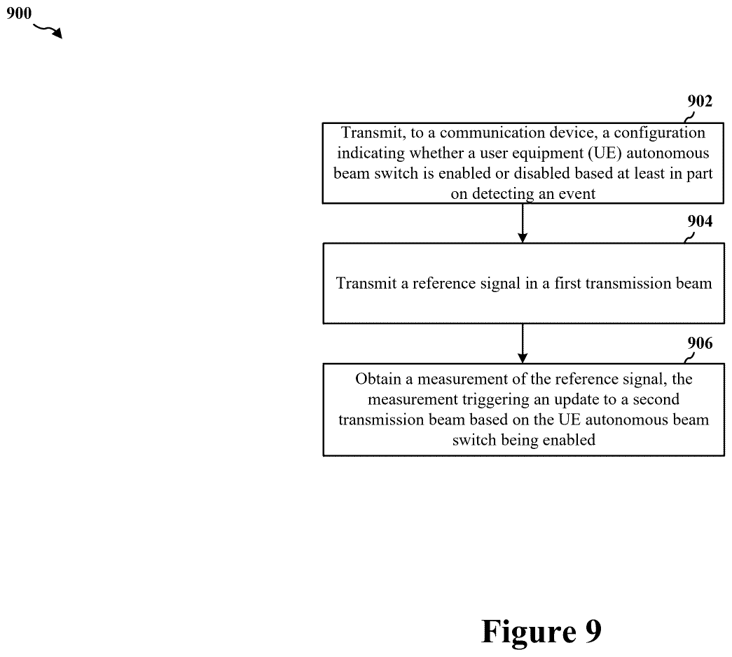

FIG. 9 is a flowchart 900 of a method of an example method or process of wireless communication. The method may be performed by a network entity such as a base station or one or more of its components, for example, the base station 102/180, 410, 702; disaggregated base station 181 or one or more of its components; one or more of RX processor(s) 470, TX processor(s) 416, or controller(s)/processor(s) 475; the apparatus 1102; or baseband unit(s) 1104 or its components. Optional aspects are illustrated in dashed lines. The method allows a network entity to transmit a configuration to disable or enable UE autonomous beam update, thereby reducing signaling overhead by saving TCI switch signaling and latency and to avoid TCI misalignment between the base station and UE.

At block 902, the network entity may transmit, to a communications device, a configuration indicating whether a UE autonomous beam switch is enabled or disabled. For example, block 902 may be performed by the configuration component 1140. Sending the configuration may include, for example, encoding, modulating, and transmitting the configuration using one or more of TX processor(s) 416 or controller(s)/processor(s) 475 such as described with respect to base station 410 in FIG. 4. As an example, referring back to FIG. 7, the base station 702 may transmit a configuration indicating whether a UE autonomous beam switch is enabled or disabled 701.

At block 904, the network entity may transmit a reference signal (RS) in a first transmission beam. For example, block 904 may be performed by the reference signal component 1142. As an example, referring back to FIG. 7, the base station 702 may transmit a reference signal 712 in a first transmission beam to the UE 704.

At block 906, the network entity may obtain a measurement of the reference signal. The measurement may trigger an update to a second transmission beam based on the UE autonomous beam switch being enabled. For example, block 906 may be performed by the measurement component 1144. As an example, referring back to FIG. 7, the base station 702 may obtain a measurement of the reference signal from the UE 704.

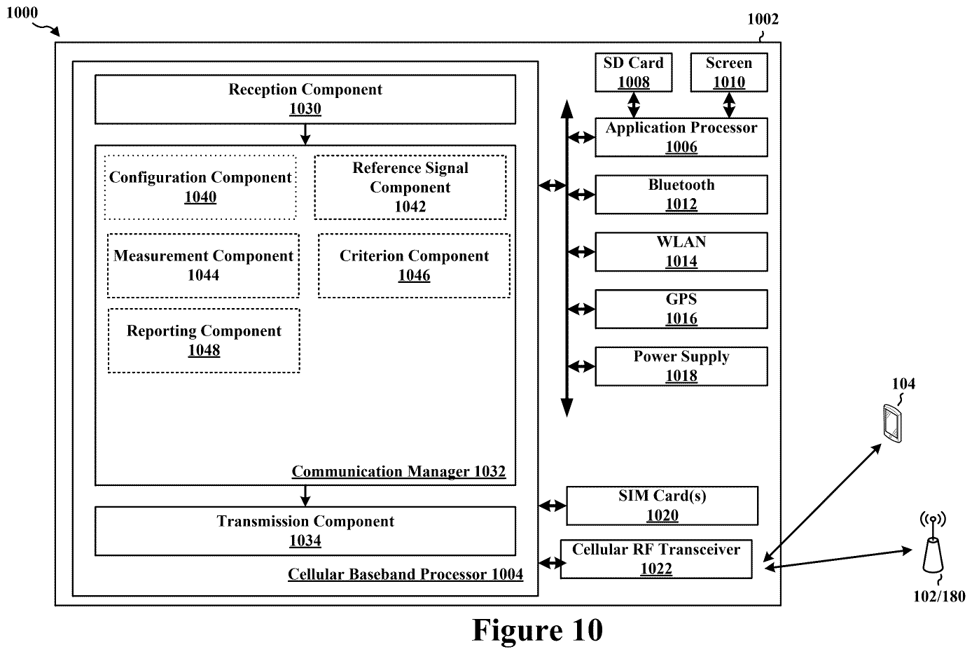

FIG. 10 is a diagram 1000 illustrating an example of a hardware implementation for an apparatus 1002. The apparatus 1002 is a UE and includes one or more cellular baseband processors 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The one or more cellular baseband processors 1004 communicate through the cellular RF transceiver 1022 with the BS 102/180/disaggregated base station 181. For example, the cellular RF transceiver 1022 may correspond to or include the transmitters 454 TX, receivers 454 RX, and antennas 452 of UE 350.

The one or more cellular baseband processors 1004 may each include a computer-readable medium/one or more memories. The computer-readable medium/one or more memories may be non-transitory. The one or more cellular baseband processors 1004 are responsible for general processing, including the execution of software stored on the computer-readable medium/one or more memories individually or in combination. The software, when executed by the one or more cellular baseband processors 1004, causes the one or more cellular baseband processors 1004 to, individually or in combination, perform the various functions described supra. The computer-readable medium/one or more memories may also be used individually or in combination for storing data that is manipulated by the one or more cellular baseband processors 1004 when executing software. The one or more cellular baseband processors 1004 individually or in combination further include a reception component 1030, a communication manager 1032, and a transmission component 1034. The communication manager 1032 includes the one or more illustrated components. The components within the communication manager 1032 may be stored in the computer-readable medium/one or more memories and/or configured as hardware within the one or more cellular baseband processors 1004. The one or more cellular baseband processors 1004 may be components of the UE 450 and may individually or in combination include the one or more memories 460 and/or at least one of the one or more TX processors 468, at least one of the one or more RX processors 456, and at least one of the one or more controllers/processors 459. For example, the reception component 1030 may include at least the one or more RX processors 456, the transmission component 1034 may include at least the one or more TX processors 468, and the communication manager 1032 may include at least the one or more controllers/processors 459. In one configuration, the apparatus 1002 may be a modem chip and include just the one or more baseband processors 1004, and in another configuration, the apparatus 1002 may be the entire communications device (e.g., see UE 450 of FIG. 4) and include the aforediscussed additional modules of the apparatus 1102.

The communication manager 1032 includes a configuration component 1040 that is configured to obtain, from a network entity, a configuration indicating whether a UE autonomous beam switch is enabled or disabled, such as described in connection with block 802. The communication manager 1032 further includes a reference signal component 1042 that is configured to obtain a reference signal in a first transmission beam, such as described in connection with block 804. The communications manager 1032 further includes a measurement component 1044 that is configured to obtain a measurement of the reference signal, the measurement triggering an update to a second transmission beam based on the UE autonomous beam switch being enabled, such as described in connection with block 806. The communications manager 1032 further includes a criterion component 1046 that is configured to, based on a determination that UE autonomous beam switch is enabled, obtain a criterion or a metric for the apparatus to update a beam, such as described in connection with block 812. The communications manager 1032 further includes a reporting component 1048 that is configured to transmit a CSI report indicating the measurement of the reference signal, such as described in connection with block 814.

The apparatus may include additional components that perform each of the blocks of the algorithm in the aforementioned flowcharts of FIGS. 7 and 8. As such, each block in the aforementioned flowcharts of FIGS. 7 and 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1002, and in particular the one or more cellular baseband processors 1004, includes means for obtaining, from a network entity, a configuration indicating whether a user equipment (UE) autonomous beam switch is enabled or disabled; means for obtaining a reference signal in a first transmission beam; and means for obtaining a measurement of the reference signal, the measurement triggering an update to a second transmission beam based on the UE autonomous beam switch being enabled.

The aforementioned means may be one or more of the aforementioned components of the apparatus 1002 configured to perform the functions recited by the aforementioned means. As described supra, the apparatus 1002 may include the one or more TX Processors 468, the one or more RX Processors 456, and the one or more controllers/processors 459. As such, in one configuration, the aforementioned means may be at least one of the one or more TX Processors 468, at least one of the one or more RX Processors 456, or at least one of the one or more controllers/processors 459, individually or in any combination configured to perform the functions recited by the aforementioned means.

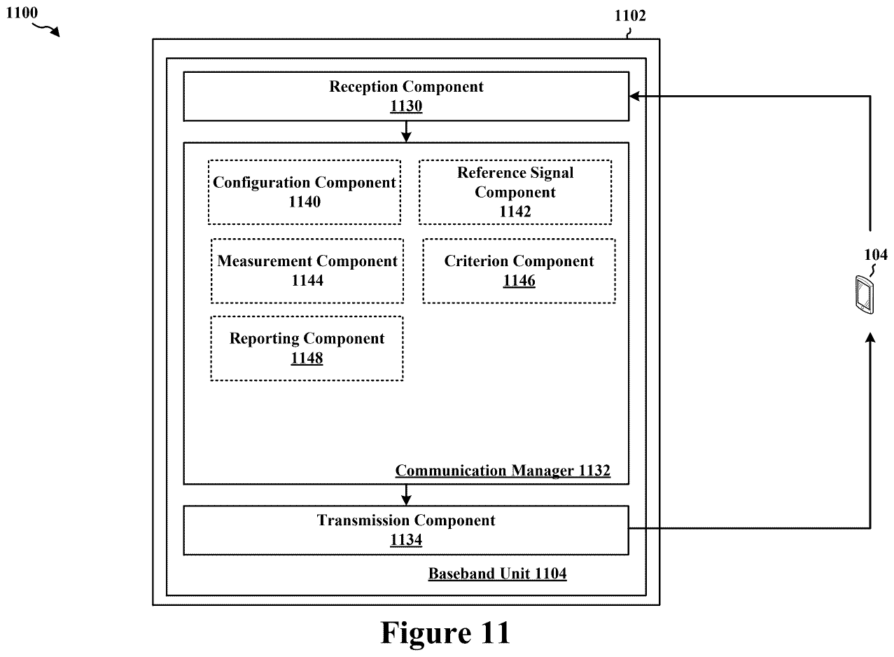

FIG. 11 is a diagram 1100 illustrating an example of a hardware implementation for an apparatus 1102. The apparatus 1102 is a network entity such as a base station, and includes one or more baseband units 1104. The one or more baseband units 1104 communicate through a cellular RF transceiver with the UE 104. For example, the cellular RF transceiver may correspond to or include the transmitters 318 TX, receivers 318 RX, and antennas 320 of base station 310.

The one or more baseband units 1104 may each include a computer-readable medium/one or more memories. The computer-readable medium/one or more memories may be non-transitory. The one or more baseband units 1104 are responsible for general processing, including the execution of software stored on the computer-readable medium/one or more memories individually or in combination. The software, when executed by the one or more baseband units 1104, causes the one or more baseband units 1104 to, individually or in combination, perform the various functions described supra. The computer-readable medium/one or more memories may also be used individually or in combination for storing data that is manipulated by the one or more baseband units 1104 when executing software. The one or more baseband units 1104 individually or in combination further include a reception component 1130, a communication manager 1132, and a transmission component 1134. The communication manager 1132 includes the one or more illustrated components. The components within the communication manager 1132 may be stored in the computer-readable medium/one or more memories and/or configured as hardware within the one or more baseband units 1104. The one or more baseband units 1104 may be components of the base station 410 and may individually or in combination include the one or more memories 476 and/or at least one of the one or more TX processors 416, at least one of the one or more RX processors 470, and at least one of the one or more controllers/processors 475. For example, the reception component 1130 may include at least the one or more RX processors 470, the transmission component 1134 may include at least the one or more TX processors 416, and the communication manager 1132 may include at least the one or more controllers/processors 475.

The communication manager 1132 includes a configuration component 1140 that is configured to transmit, to a communication device, a configuration indicating whether a UE autonomous beam switch is enabled or disabled, such as described in connection with block 902. The communication manager 1132 further includes a reference signal component 1142 that is configured to transmit a reference signal in a first transmission beam, such as described in connection with block 904. The communication manager 1132 further includes a measurement component 1144 that is configured to obtain a measurement of the reference signal, the measurement triggering an update to a second transmission beam based on the UE autonomous beam switch being enabled, such as described in connection with block 906.

The apparatus may include additional components that perform each of the blocks of the algorithm in the aforementioned flowchart of FIGS. 7 and 9. As such, each block in the aforementioned flowchart of FIGS. 7 and 9 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1102, and in particular the one or more baseband unit(s) 1104, includes means for transmitting a configuration indicating whether a user equipment (UE) autonomous beam switch is enabled or disabled; means for obtaining a reference signal in a first transmission beam; and means for obtaining a measurement of the reference signal, the measurement triggering an update to a second transmission beam based on the UE autonomous beam switch being enabled.

The aforementioned means may be one or more of the aforementioned components of the apparatus 1102 configured to perform the functions recited by the aforementioned means. As described supra, the apparatus 1102 may include the one or more TX Processors 416, the one or more RX Processors 470, and the one or more controllers/processors 475. As such, in one configuration, the aforementioned means may be at least one of the one or more TX Processors 416, at least one of the one or more RX Processors 470, or at least one of the one or more controllers/processors 475, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain, from a network entity, a configuration indicating whether a user equipment (UE) autonomous beam switch is enabled or disabled; obtain a reference signal in a first transmission beam; and obtain a measurement of the reference signal, the measurement triggering an update to a second transmission beam based on the UE autonomous beam switch being enabled.

Clause 2. The apparatus of clause 1, wherein the first transmission beam is indicated by a first transmission configuration indicator (TCI) state.

Clause 3. The apparatus of clause 2, wherein the reference signal is utilized for various measurements including at least one of Time-Reference Signal (TRS), Pathloss Reference Signal (PL RS), or Beam Failure Detection/Radio Link Monitoring Reference Signal (BFD/RLM RS) associated with each transmission configuration indicator (TCI).

Clause 4. The apparatus of clause 3, wherein the TCI selection is from a normal configured TCI pool.

Clause 5. The apparatus of clause 4, wherein the TCI selection is from a dedicated TCI pool, wherein the dedicated TCI pool is a subset of the normal configured TCI pool.

Clause 6. The apparatus of any of clauses 1 to 5, wherein the reference signal is obtained from a set of configured reference signals comprising at least one of Synchronization Signal Blocks (SSBs) or periodic Channel State Information Reference Signal (P CSI-RS).

Clause 7. The apparatus of any of clauses 1 to 6, wherein the one or more processors, individually or in any combination, are further operable to cause the apparatus to:
based on the reference signal corresponding to an uplink, use the reference signal as Path Loss Reference Signal (PL RS); and obtaining Power Control (PC) parameters from a base station, wherein the PC parameters comprise at least one of Initial Power Offset (P0), Power Control Alpha Parameter (alpha), or closed loop index.

Clause 8. The apparatus of any of clauses 1 to 7, wherein the configuration indicating whether the UE autonomous beam switch is enabled or disabled is obtained via an explicit Radio Resource Control (RRC) flag such that the reference signal is applied to at least one channel or reference signal in an indicated range of the explicit RRC flag.

Clause 9. The apparatus of any of clauses 1 to 8, wherein the configuration indicating whether the UE autonomous beam switch is enabled or disabled is obtained via dynamic signaling.

Clause 10. The apparatus of any of clauses 2 to 9, wherein the configuration indicating whether a UE autonomous beam switch is enabled or disabled is obtained by an implicit rule comprising at least one of: (1) enabling the UE autonomous beam switch based on a determination of no Quasi-Co-Located (QCL)-TypeD RS in the TCI for DL/UL beam indication; (2) applying the configuration to a predetermined bandwidth; (3) applying the reference signal to a target channel or reference signal based on a target having no TCI provided by a base station; (4) not applying the reference signal to a target reference signal serving as root QCL source RS, wherein such CSI-RS can be indicated to the apparatus; (5) applying the reference signal based on a number of configured beams being above a predetermined threshold; and (6) applying the reference signal based on a number of configured beams being below the predetermined threshold.

Clause 13. The apparatus of any of clauses 1 to 19, wherein the one or more processors, individually or in any combination, are further operable to cause the apparatus to: transmit a channel state information (CSI) report indicating the measurement of the reference signal.

Clause 14. The apparatus of clause 13, wherein the CSI report is transmitted based on detecting a change in the measurement of the reference signal.

Clause 15. The apparatus of clause 13, wherein the CSI report is transmitted periodically.

Clause 16. The apparatus of clause 13, wherein the CSI report is transmitted based on obtaining a request.

Clause 17. The apparatus of clause 2, wherein the TCI state comprises a subset of joint DL/UL TCI state, separate DL TCI state, or a separate UL TCI state.

Clause 18. The apparatus of clause 2, wherein the TCI state includes a joint DL/UL TCI state, separate DL TCI state, and a separate UL TCI state.

Clause 19. A method of wireless communication performable at a user equipment (UE), comprising: obtaining, from a network entity, a configuration indicating whether a UE autonomous beam switch is enabled or disabled; obtaining a reference signal (RS) in a first transmission beam; and obtaining a measurement of the reference signal, the measurement triggering an update to a second transmission beam based on the UE autonomous beam switch being enabled.

Clause 20. An apparatus for wireless communication, comprising: one or more memories; and one or more processors each communicatively coupled with at least one of the one or more memories, the one or more processors, individually or in any combination, operable to cause the apparatus to: transmit, to a communications device, a configuration indicating whether a UE autonomous beam switch is enabled or disabled; transmit a reference signal (RS) in a first transmission beam; and obtain a measurement of the reference signal, the measurement triggering an update to a second transmission beam based on the UE autonomous beam switch being enabled.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain, from a network entity, a configuration indicating whether a user equipment (UE) autonomous beam switch is enabled or disabled;
obtain a reference signal in a first transmission beam; and
obtain a measurement of the reference signal, the measurement triggering an update to a second transmission beam based on the UE autonomous beam switch being enabled.

2. The apparatus of claim 1, wherein the first transmission beam is indicated by a first transmission configuration indicator (TCI) state.

3. The apparatus of claim 2, wherein the reference signal is utilized for various measurements comprising at least one of Time-Reference Signal (TRS), Path Loss Reference Signal (PL RS), or Beam Failure Detection/Radio Link Monitoring Reference Signal (BFD/RLM RS) associated with each transmission configuration indicator (TCI).

4. The apparatus of claim 3, wherein the TCI selection is from a normal configured TCI pool.

5. The apparatus of claim 4, wherein the TCI selection is from a dedicated TCI pool, wherein the dedicated TCI pool is a subset of the normal configured TCI pool.

6. The apparatus of claim 1, wherein the reference signal is obtained from a set of configured reference signals comprising at least one of Synchronization Signal Blocks (SSBs) or periodic Channel State Information Reference Signal (P CSI-RS).

7. The apparatus of claim 1, wherein the one or more processors, individually or in any combination, are further operable to cause the apparatus to:
based on the reference signal corresponding to an uplink, using the reference signal as the PL RS; and
obtaining Power Control (PC) parameters from a base station, wherein the PC parameters comprise at least one of Initial Power Offset (P0), Power Control Alpha Parameter (alpha), or closed loop index.

8. The apparatus of claim 1, wherein the configuration indicating whether the UE autonomous beam switch is enabled or disabled is obtained via an explicit Radio Resource Control (RRC) flag such that the reference signal is applied to at least one channel or reference signal in an indicated range of the explicit RRC flag.

9. The apparatus of claim 1, wherein the configuration indicating whether the UE autonomous beam switch is enabled or disabled is obtained via dynamic signaling.

10. The apparatus of claim 2, wherein the configuration indicating whether a UE autonomous beam switch is enabled or disabled is obtained by an implicit rule comprising at least one of:
(1) enabling the UE autonomous beam switch based on a determination of no Quasi-Co-Located (QCL)-TypeD RS being present in the TCI for DL/UL beam indication;
(2) applying the configuration to a predetermined bandwidth;
(3) applying the reference signal to a target channel or reference signal based on a target having no TCI provided by a base station;
(4) not applying the reference signal to a target reference signal serving as root QCL source RS, wherein such CSI-RS can be indicated to the apparatus;
(5) applying the reference signal based on a number of configured beams being above a predetermined threshold; and
(6) applying the reference signal based on a number of configured beams being below the predetermined threshold.

11. The apparatus of claim 1, wherein the one or more processors, individually or in any combination, are further operable to cause the apparatus to:
based on a determination that UE autonomous beam switch is enabled, obtaining a criterion or a metric for the apparatus to update a beam.

12. The apparatus of claim 1, wherein obtaining the configuration indicating whether the UE autonomous beam switch is enabled or disabled is based at least in part on detecting an event, wherein the event comprises at least one of:
(1) quality of at least one new beam has a threshold value greater than a current beam;
(2) quality of the current beam is lower than a first threshold and quality of at least one new beam is greater than a second threshold;
(3) an absolute value of a difference between a quality of the current beam and the quality of at least one new beam is lower than a third threshold;
(4) quality of more than one new beam becomes a threshold value greater than the current beam; and
(5) quality of at least one new beam becomes a threshold value better than a configured reference signal of SSB or CSI-RS.

13. The apparatus of claim 1, wherein the one or more processors, individually or in any combination, are further operable to cause the apparatus to:
transmit a channel state information (CSI) report indicating the measurement of the reference signal.

14. The apparatus of claim 13, wherein the CSI report is transmitted based on detecting a change in the measurement of the reference signal.

15. The apparatus of claim 13, wherein the CSI report is transmitted periodically.

16. The apparatus of claim 13, wherein the CSI report is transmitted based on obtaining a request.

17. The apparatus of claim 2, wherein the TCI state comprises a subset of joint DL/UL TCI state, separate DL TCI state, or a separate UL TCI state.

18. The apparatus of claim 2, wherein the TCI state comprises a joint DL/UL TCI state, separate DL TCI state, and a separate UL TCI state.

19. A method of wireless communication performable at a user equipment (UE), comprising:
obtaining, from a network entity, a configuration indicating whether a UE autonomous beam switch is enabled or disabled;
obtaining a reference signal (RS) in a first transmission beam; and
obtaining a measurement of the reference signal, the measurement triggering an update to a second transmission beam based on the UE autonomous beam switch being enabled.

20. An apparatus for wireless communication, comprising:
one or more memories; and
one or more processors each communicatively coupled with at least one of the one or more memories, the one or more processors, individually or in any combination, operable to cause the apparatus to:
transmit, to a communications device, a configuration indicating whether a UE autonomous beam switch is enabled or disabled;
transmit a reference signal (RS) in a first transmission beam; and
obtain a measurement of the reference signal, the measurement triggering an update to a second transmission beam based on the UE autonomous beam switch being enabled.
